(19) United States
(12) Patent Application Publication
(10) Pub. No.: US 2018/0012094 A1
(43) Pub. Date: Jan. 11, 2018

(54) SPOOFING ATTACK DETECTION DURING LIVE IMAGE CAPTURE

(71) Applicant: MorphoTrust USA, LLC, Billerica, MA (US)

(72) Inventors: Yecheng Wu, Lexington, MA (US); Brian Martin, McMurray, PA (US)

(21) Appl. No.: 15/642,173

(22) Filed: Jul. 5, 2017

Related U.S. Application Data
(60) Provisional application No. 62/358,531, filed on Jul. 5, 2016.

(51) Int. Cl. G06K 9/00; G06T 7/60

(52) U.S. Cl. CPC G06K 9/00906; G06K 9/00604; G06T 7/90; G06T 7/60; G06K 9/0061; G06T 7/13; G06K 9/00295; G06K 9/00255; G06T 2207/10024; G06T 2207/30201

(57) ABSTRACT

In general, one innovative aspect of the subject matter described in this specification can be embodied in a computer-implemented method. The method includes, detecting, by an imaging device, the presence of an object to be imaged. The method further includes, measuring, by the imaging device, a first characteristic of the object to be imaged, and measuring, by the imaging device, a second characteristic of the object to be imaged. The method further includes, determining, by a computing device, that at least one of the first characteristic of the object or the second characteristic of the object exceeds a threshold; and in response to determining, indicating, by the computing device, whether the object to be imaged is one of a spoofed object or an actual object.

### FIELD

The present specification is related generally to detection of a spoofing attack during live image capture.

### BACKGROUND

Physical identification cards such as driver licenses are commonly used for verifying the identity of an individual, providing access to restricted areas, authorizing an individual to purchase age-restricted content, or authorizing an individual to access networked computing resources.

### SUMMARY

Physical identification cards are provided by issuing authorities such as government agencies or companies to users during an issuance process. When issuing authorities generate identification cards that have an image of the user, acquisition or capture of the image by an imaging device such as a camera or smartphone/cellular device may be susceptible to one or more spoofing attacks.

Such physical identification cards often include an image of the user that is used to identify the identity of the user, and in some instances, provide access or privileges to the user. Spoofing attacks that occur during live image capture may severely compromise user authentication in the context of physical and/or network security especially when such images are captured to generate identification cards or digital identifications that provide user access to restricted areas or sensitive electronic media.

In general, one innovative aspect of the subject matter described in this specification can be embodied in a computer-implemented method. The method includes detecting, by an imaging device, the presence of an object to be imaged. The method may further include measuring, by the imaging device, a distance between the imaging device and the object to be imaged. Additionally, the method may include, using, by a computing device, the measured distance and at least one feature of the imaging device to determine a characteristic of the object to be imaged. The method can further include determining, by the computing device, whether the characteristic of the object exceeds a threshold; and indicating, by the computing device, whether the object to be imaged is one of a spoofed object and an actual object.

These and other implementations can each optionally include one or more of the following features. For example, the determined characteristic of the object to be imaged may be the size of the object. In some implementations, the at least one feature of the imaging device includes one of focal length of a lens of the imaging device, size of an imaging sensor of the imaging device, image pixel resolution of the imaging sensor, and object size on the image in pixels. In one aspect of the subject matter described in this specification, determining the characteristic of the object to be imaged includes using a width of an image detected by the imaging device and a width of the imaging sensor.

In another aspect, the object to be imaged is a human face and the distance between the imaging device and the object is measured based on a distance between a first pupil of the human face and a second pupil of the human face. In yet another aspect, the distance between a first pupil of the human face and a second pupil of the human face may be a distance in pixels associated with an image detected by the imaging device.

In general, another innovative aspect of the subject matter described in this specification can be embodied in a computer-implemented method. The method includes detecting, by an imaging device, the presence of an object to be imaged, determining, by the imaging device, a first characteristic of the object to be imaged; and determining, by the imaging device, a second characteristic of the object to be imaged. The method also includes, determining, by a computing device, whether a parameter value exceeds a threshold parameter value, where the parameter value indicates the first characteristic or the second characteristic. In response to determining whether the parameter value exceeds the threshold parameter value, the method includes, indicating, by the computing device, that the object to be imaged is one of a spoofed object or an actual object.

These and other implementations can each optionally include one or more of the following features. For example, in some implementations, the parameter value indicates at least one of: a characteristic of at least a subset of pixel data associated with image data for the object to be imaged; or a color property of at least one image area of the image data for the object to be imaged.

In some implementations, determining whether the parameter value exceeds the threshold parameter value comprises: analyzing the pixel data to determine whether one or more pixels are oversaturated; in response to determining whether one or more pixels are oversaturated, computing a percentage of pixels that are determined to be oversaturated; and determining a magnitude of pixel saturation based on the percentage of pixels that are determined to be oversaturated. In some implementations, a higher percentage of oversaturated pixels indicates a higher probability that an object to be imaged is an electronic device for displaying a spoofing image. In some implementations, the first characteristic of the object to be imaged is a glare property of the object, a reflection property of the object, or the glare property and the reflection property.

In some implementations, the object is an electronic device having a display screen, the electronic device including detectable attributes that are associated with a glare property of the object, a reflection property of the object, or a frame of the object. In some implementations, the second characteristic of the object to be imaged is an edge property of the object, a background property of an image depicting the object, or the edge property of the object and the background property of the image depicting the object.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 illustrates a block diagram of an example system for spoofing attack detection during live image capture.

FIG. 2 illustrates an equation and one or more parameters used for spoofing attack detection during live image capture.

FIG. 3 illustrates another block diagram of an example system for spoofing attack detection during live image capture.

FIG. 4 illustrates a flowchart of an example process for spoofing attack detection during live image capture.

FIG. 5 illustrates another block diagram of an example system for spoofing attack detection during live image capture.

FIG. 6 illustrates another flowchart of an example process for spoofing attack detection during live image capture.

Like reference numbers and designations in the various drawings indicate like elements.

### DETAILED DESCRIPTION

In general, systems and methods are described for detection of spoofing attacks during live image capture. In the context of network and physical security, a spoof may be defined as an intent to deceive for the purpose of gaining access to another's resources such as, for example, by faking an internet address so that a nefarious user resembles a legitimate internet user. Moreover, a spoof can also include attempts to simulate a communications protocol by a program that is interjected into a normal sequence of processes for the purpose of addition some nefarious function.

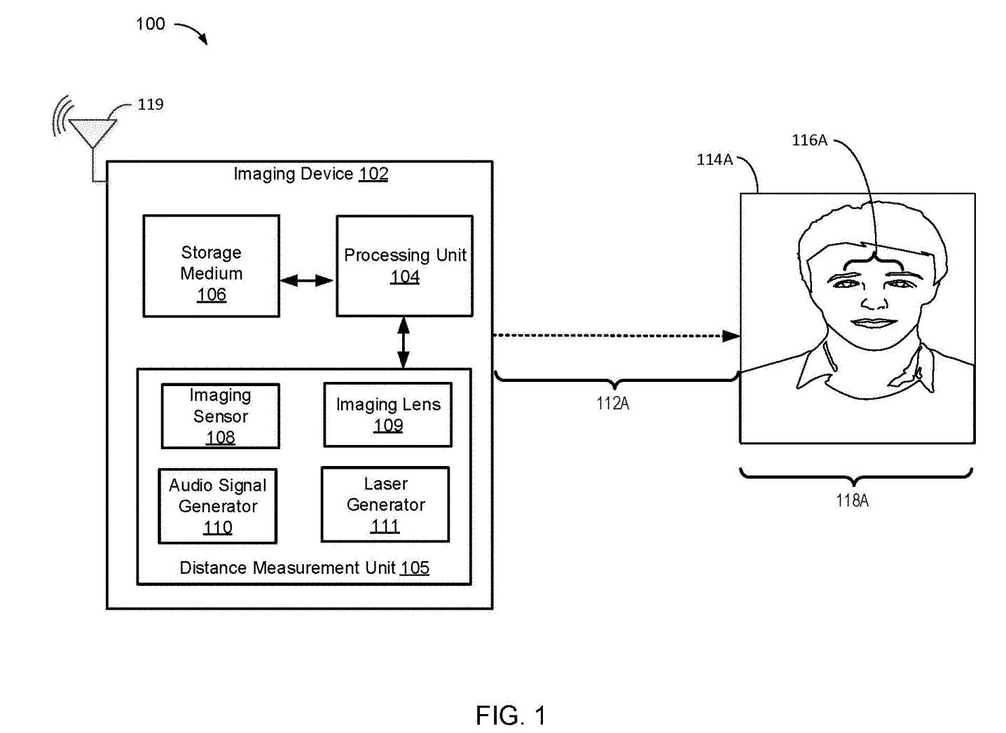

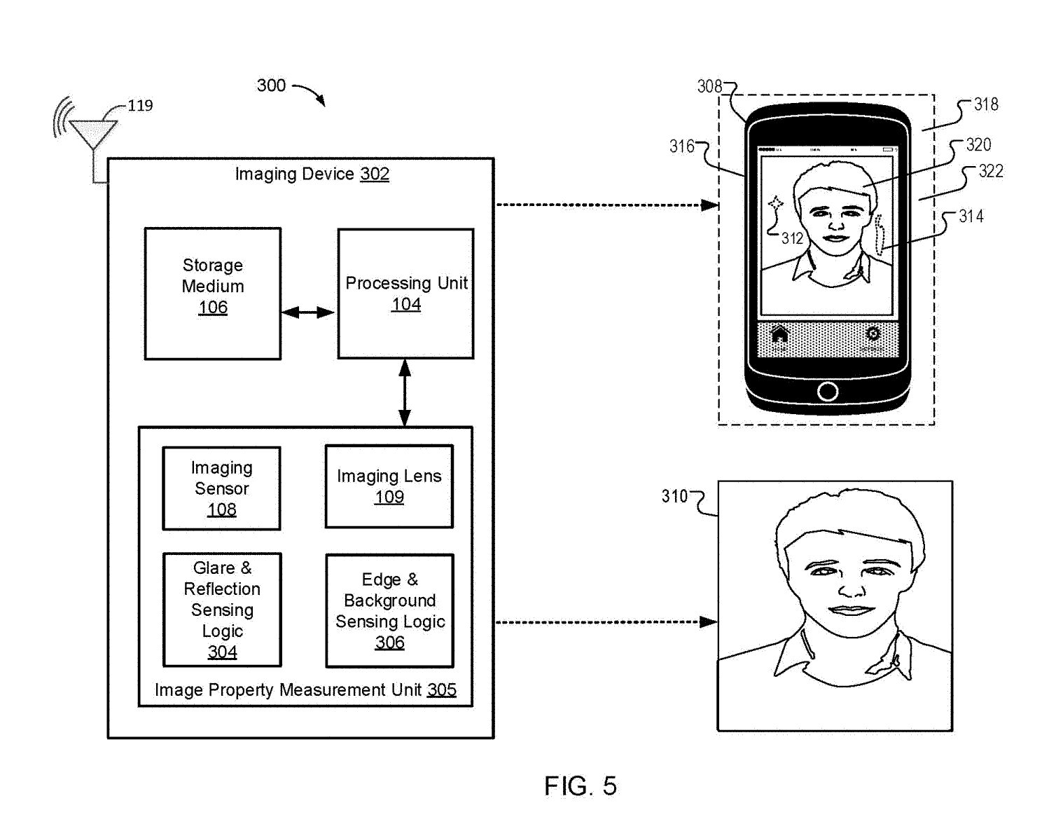

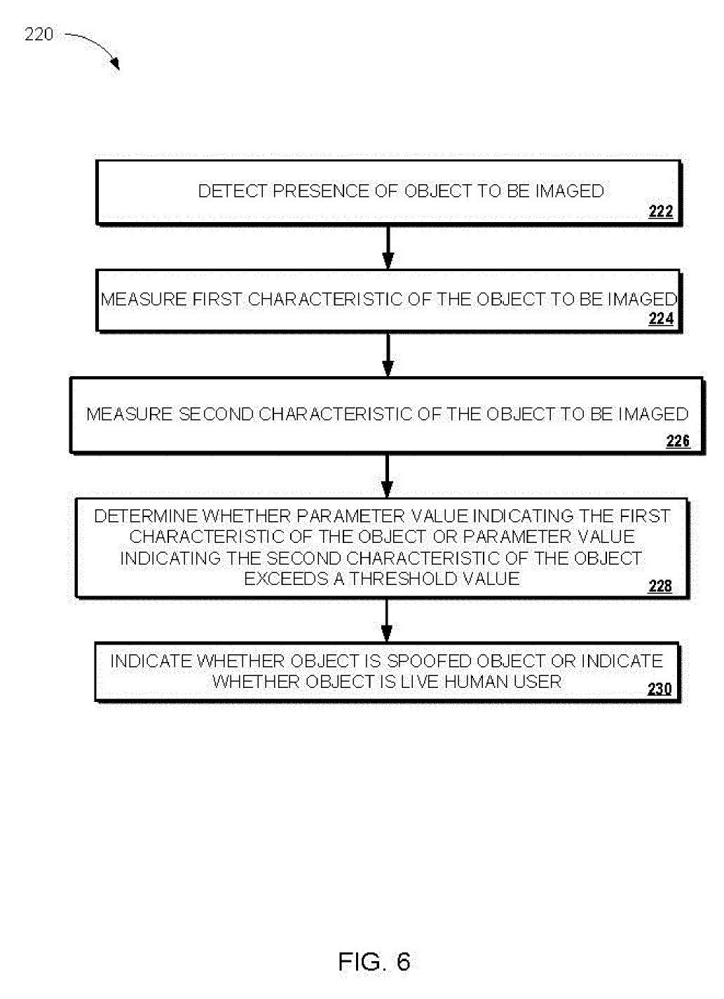

Within this context, the described subject matter includes approaches for detection of spoofing attacks during live image capture, where detection is based on a distance measurement and a size of an object being captured, shown in FIGS. 1-4. This specification further describes approaches for detection of spoofing attacks during live image capture, where detection is based on image properties related to a potential spoof rendering device(s), shown in FIGS. 5-6.

A spoofing attack is generally when a malicious unauthorized party impersonates a legitimate authorized user or device within computing or networked environments. The spoofing attack is typically used to gain access to certain resources, launch attacks against network hosts, steal sensitive or other data, spread malware or bypass access controls. In certain scenarios, impersonation may take the form of a still-photo and/or a video/replay in which the attacker uses a still image or replays a video of the legitimate client using a digital device such as a mobile phone, tablet device or laptop computer.

To detect the occurrence of spoofing attacks during live image capture, the technology described herein provides one or more systems and methods that include measuring the distance between a lens of an example imaging device and the object to be imaged (e.g., a user). The systems and methods described in this specification use the distance and at least one technical feature or technical characteristic of the imaging device (e.g., camera optics) to determine or calculate the size of the object being imaged. Based on the measured distance and the determined size of the object, the systems and methods determine whether the object is a real/actual live human user or an object that is the basis for a spoofing attack.

Identifying and authenticating if an object being imaged is an actual live object or a spoof is an important step in the successful creation and enrollment of trusted identity documents. Due to the lack of automated spoofing attack detection technologies, most enrollment and image capture processes are performed in front of a human operator. Image capture processes performed in front of human operators require one or more trained persons to manage operation of on-site image acquisition systems.

Moreover, operators are also required to travel to specific locations where the image acquisition occurs. These requirements are often time consuming and costly to all parties associated with the credentialing and identity verification process. Additionally, for remote credentialing and verification processes, a lack of spoofing attack detection can potentially lead to unauthorized subjects being granted access to secure systems when spoofed images or videos are used in place of an actual human user.

FIG. 1 illustrates a block diagram of an example system 100 for spoofing attack detection during live image capture. System 100 generally includes imaging device 102. In an alternative embodiment, in addition to imaging device 102, system 100 may further include an example human user such as user 114A. In some implementations, imaging device 102 may be a camera, a laptop computer, a desktop computer, a cellular smartphone device (e.g., an iPhone, Samsung Galaxy, or an Android device), or any other electronic device capable of capturing an image of a user.

Imaging device 102 generally includes processing unit 104, storage medium 106, and distance measurement unit 105. In an alternative embodiment, system 100 may include other computing resources/devices (e.g., cloud-based servers) that provide additional processing options for performing one or more the determinations and calculations described below.

Processing unit 104 is configured to process a computer program having instructions for execution within imaging device 102, including instructions stored in storage medium 106 or other instructions stored in another storage device. The processing unit 104 may include one or more processors. The storage medium 106 stores information within the imaging device 102. In some implementations, the storage medium 106 is a volatile memory unit or units. In some other implementations, the storage medium 106 is a non-volatile memory unit or units.

The storage medium 106 may also be another form of computer-readable medium, such as a floppy disk device, a hard disk device, an optical disk device, a tape device, a flash memory or other similar solid state memory device, or an array of devices, including devices in a storage area network or other configurations. The above-mentioned computer program and instructions, when executed by the processing unit 104, cause the processing unit 104 to perform one or more tasks, as described in further detail herein below.

Distance measurement unit (DMU) 105 generally includes, imaging sensor 108, imaging lens 109, audio signal generator 110, and laser generator 111. DMU 105 cooperates with processing unit 104 and storage medium 106 to perform a plurality of operations and tasks relative to spoofing attack detection when imaging device 102 prepares to capture or acquire an image of a human user 114A. As used herein, a “user” may refer to a human individual. For example, a user may be an individual desiring a physical identification card such as a driver's license issued by a department of motor vehicles of a territory or a municipality. In other instances, the identification card may be other types of identifications such as a passport, or other government or company-issued identification cards having an identifying image of user 114A affixed to the card.

In some implementations, user 114A may desire to enroll into a digital identification program that uses various methods such as, for example, an online enrollment process or remote form submission process in which an authorized representative receives and relies on an electronic photograph/image of user 114A to process enrollment into an identity verification program. A digital identification administrator may then create a user entry including user information in an identification database. For instance, the user information may include one or more of an email address, an identification number, the electronic photograph/image of user 114A, and other types of demographic information (e.g., home address) associated with user 114A.

A malicious or hostile individual or entity desiring access to sensitive information may seek to engage in unauthorized or fraudulent enrollment via the digital identification program by using a spoofed electronic photograph or digital image of user 114A. Additionally, the malicious/hostile user may also seek to use spoofed images of user 114A to circumvent physical security measures that rely, in part, on biometric information such as facial or iris features of user 114A to grant access to facilities. This specification therefore provides systems and method that enhance the integrity of online or remote identity enrollment processes by reliably detecting spoofed images that are used for unauthorized or fraudulent identity verification.

Referring again to FIG. 1, imaging device 102 is generally configured to capture an image of an object such as user 114A. In the embodiment of FIG. 1, user 114A is a live human user having facial and iris features that correspond to a human male or human female. Imaging device 102 is generally configured to sense or detect the presence of an object to be imaged. In some implementations, imaging device 102 may incorporate conventional object sensing and detection technology such as passive or active infrared sensors or known motion detection methods to detect the presence of an object adjacent to the device. A variety of other related object sensing technologies may be utilized by imaging device 102 to detect the presence of an object to be imaged.

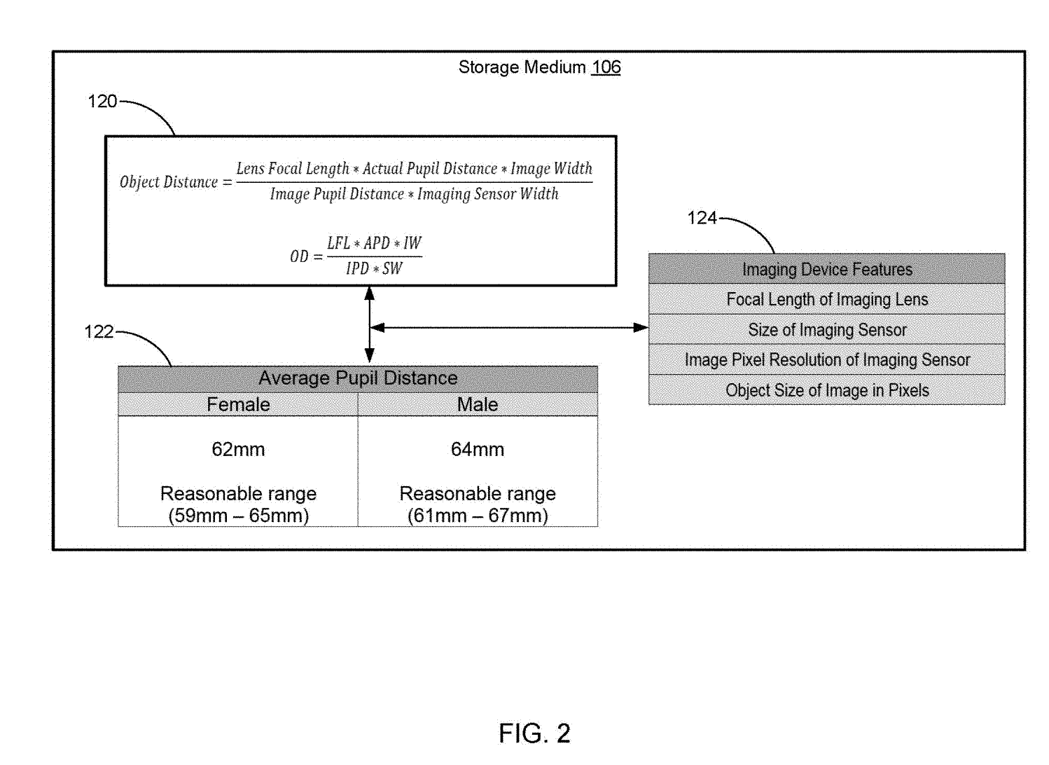

DMU 105 is generally configured to measure the distance between imaging lens 109 (i.e., representative optical means used within an actual imaging device) and the object to be imaged. In various implementations, the object to be imaged may be a live male human user 114A or a live female human user 114A. In the embodiment of FIG. 1, distance 112A indicates the measured distance between imaging lens 109 and user 114A. Imaging device 102 uses the measured distance 112A and at least one technical feature of imaging device 102 to determine or calculate the actual size of the object to be imaged. In some implementations, the at least one technical feature of imaging device 102 includes one of: 1) the focal length of imaging lens 109, the size of imaging sensor 108, the image pixel resolution of imaging sensor 108, and the object size of the image in pixels (See FIG. 2).

Determination of the actual size of the object being imaged enables imaging device 102 to determine whether the object is an actual live human user or a spoofing attack object (e.g., still-photo or video replay). Imaging device 102 may also include a signal indicator function (indicator 119) that broadcasts, signals, or otherwise notifies an authorized system administrator of the determination regarding whether the object to be imaged is a live human user or a spoofing attack object. In one or more alternative embodiments, the actual size of the object being imaged may be determined based on calculations that occur within a computing device such as a cloud-based server device. In various implementations, the computing device may include processing and storage capabilities substantially similar to capabilities provided by processing unit 104 and storage medium 106.

A variety of methods can be deployed and used within DMU 105 for distance measurement. The various methods include use of audible and inaudible signals, use of laser signals to include laser range finding devices, use of a focus point associated with an image frame, use of multiple images acquired by imaging device 102 in a manner that is synonymous with stereo imaging, and various other known distance measuring methods supported by imaging device 102. In one implementation, audible or inaudible signal transmission generally includes transmitting one of an audible or an inaudible signal, measuring the time of the echo, and using the measured echo value to approximate object distance relative to imaging device 102.

FIG. 2 illustrates an equation and one or more parameters used for spoofing attack detection during live image capture. As shown in FIG. 2, storage medium 106 may generally include distance equation 120, pupil distance parameters 122, and imaging device features 124. In various implementations, equation 120, parameters 122 and features 124 are each stored within storage medium 106 in the form of a computer program or machine readable instruction that is accessible by processing unit 104.

In other implementations, equation 120, parameters 122 and features 124 are each stored within a storage medium of a computing device such as a cloud-based server device. While in this storage medium, equation 120, parameters 122 and features 124 will likewise be stored in the form of a computer program or machine readable instruction that is accessible by a processing unit of the computing device.

As discussed briefly above, a variety of methods can be used by imaging device 102 for object distance measurement. In some implementations, processing unit 104 utilizes equation 120 to measure the distance between an object to be imaged and imaging device 102. Equation 120 is represented as:

$$OD = \frac{LFL * APD * IW}{IPD * SW} .$$

In equation 120, LFL is the Lens Focal Length, APD is the Actual Pupil Distance 116A (FIG. 1), IW is the Image Width 118A (FIG. 1), IPD is the Image Pupil Distance, and ISW is the Imaging Sensor Width (sensor 108, FIG. 1).

As indicated above, the measured distance 112A and at least one device feature 124 are used to determine or calculate the size of the object being imaged. In some implementations, each of the device features 124 may be used in conjunction with measured distance 112A to determine or calculate the size of the object being imaged. In particular, with the measured distance 112A, the size of the object may be calculated using the imaging device focal length, the imaging sensor size and image pixel resolution, the object size on the image (in pixels) and the measured distance.

In various implementations, processing unit 104 (or a related processing unit of a non-local computing device) may be configured to compare the calculated object size with one or more known size ranges for a variety of live female and male human example faces. If the comparisons yield a size difference that is beyond (or below) a predefined threshold, a possible spoofing attack is detected and indicated by imaging device 102 or the computing device. For example, if a photo image or video is shown on the screen of a mobile phone, and imaging device 102 is preparing to capture an image of the photo or video, then the face size displayed via imaging device 102 will be much smaller than an actual live human face. Conversely, if the comparison yields a difference that is within a predefined range (i.e., does not exceed or fall below the threshold), then the object size is determined to be reasonable and is thus presumed to be a live human user.

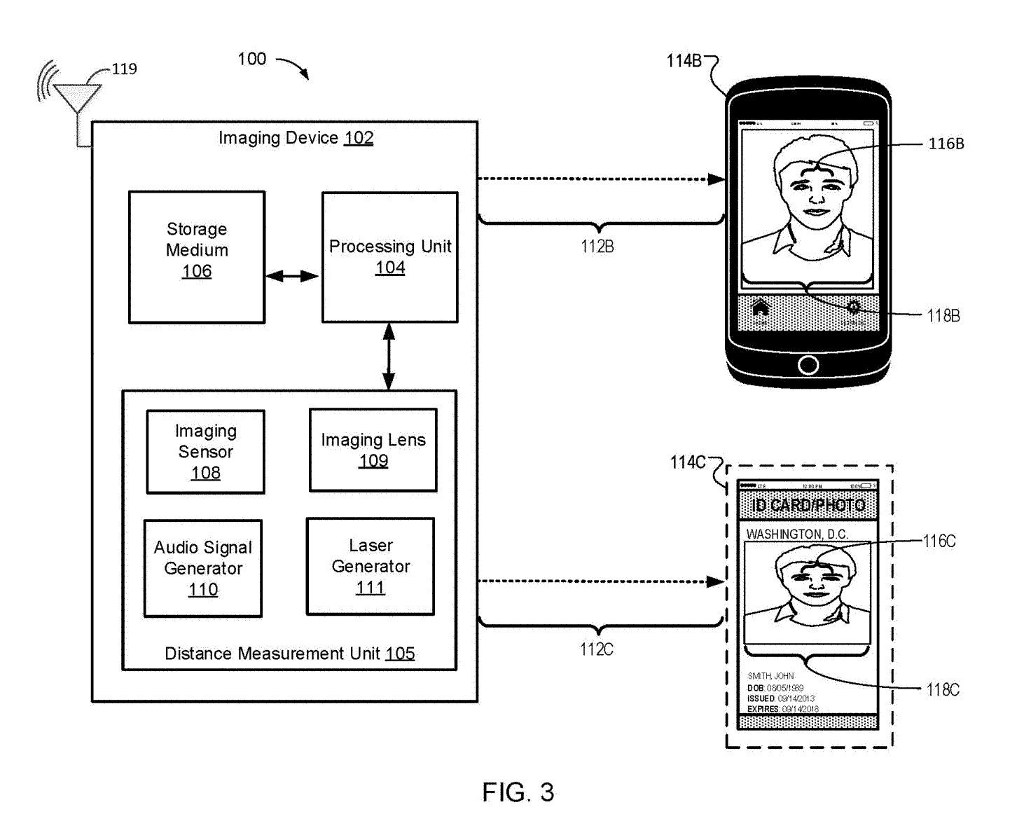

FIG. 3 illustrates another block diagram of an example system for spoofing attack detection during live image capture. The implementations of FIG. 3 show alternative embodiments in which potential spoofing attacks may be attempted. In the embodiment of FIG. 3, the object to be measured is a spoofing object such as object 114B or object 114C. As noted above, spoofing attacks may take the form of an identification card or still-photo (object 114C) and/or a video/replays (object 114B) in which the attacker uses a digital still image or replays a video of the legitimate client using a digital device such as a mobile phone, tablet device or laptop computer.

As shown, in an example spoofing attack scenario, pupil distance 116B and 116C will likely be substantially smaller than a live human user pupil distance such as distance 116A of FIG. 1. Likewise, image width 118B and 118C will likely be smaller than a width associated with a live human user such as image width 118A of FIG. 1. Moreover, measured distances 112B and 112C may also differ from measured distance 112A for a live human user.

Accordingly, when processing unit 104 (or a related processing unit of a non-local computing device) compares the calculated object size of object 114B/C with one or more known size ranges for a variety of live female/male human faces, the comparison will yield a size difference that is beyond (or below) a predefined threshold. Hence, a spoofing attack will be detected.

Additionally, imaging device 102 (or a related processing unit of a non-local computing device) may activate an indicator (such as signal indicator 119) to signal, broadcast, or otherwise notify an authorized system administrator of the determination whether the object to be imaged is a live human user or a spoofing attack object.

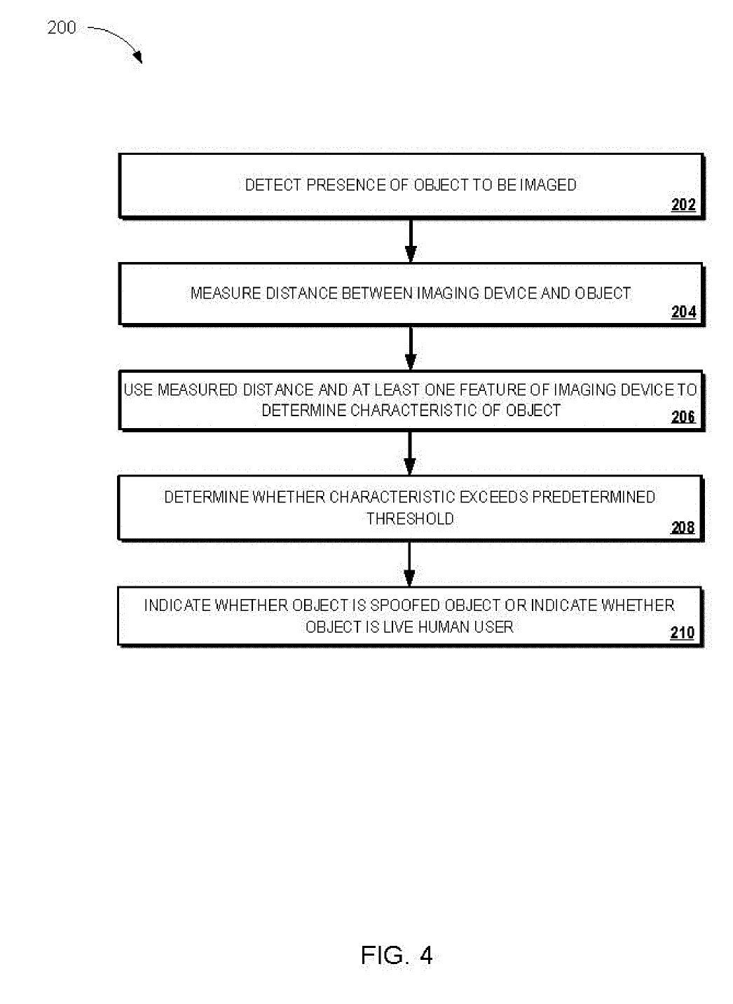

FIG. 4 illustrates a flowchart of an example process for spoofing attack detection during live image capture. Process 200 begins at block 202 and, for each image frame, imaging device 102 detects a presence of an object to be imaged which includes detecting whether the face of a live human user 114A is within the image frame. At block 204, process 200 includes imaging device 102 measuring the distance between imaging lens 109 and the object to be imaged. In some implementations, the object to be measured is a live human user 114A. In alternative embodiments in which a potential spoofing attack is attempted, the object to be measured is a spoofing object such as object 114B or object 114C.

At block 206, process 200 includes imaging device 102 (or another computing device) using the measured distance and one or more device features 124 to determine a characteristic of the object to be imaged. In one implementation, the characteristic is the size of the object to be imaged. Process 200 further includes either imaging device 102 or another computing device determining whether the characteristic or object size exceeds a predetermined threshold size (block 208).

As indicated above, in one implementation, processing unit 104, or a processor of another device, may compare the calculated object size with one or more known size ranges for a variety of live female and male human example faces. If the comparisons yield a size difference that is beyond (or below) a predefined threshold, a possible spoofing attack may be detected. At block 210, process 200 includes indicating (via signal indicator 119), transmitting, or otherwise notifying an authorized system administrator of the determination of whether the object to be imaged is a live human user or a spoofing attack object.

As noted above, FIGS. 1-4 have illustrated approaches for detection of spoofing attacks during live image capture based on a distance measurement and size of an object being captured. The remaining FIGS. 5-6 illustrate approaches for detection of spoofing attacks during live image capture based on image properties relating to a potential spoof rendering device(s).

To detect an occurrence of spoofing attacks during live image capture, the technology described below includes systems and methods for sensing or measuring one or more image properties associated with an image of an object (e.g., a human user or physical device). In some implementations, the measured image properties can relate to a potential spoof rendering device.

Example image properties that can be measured can include image glare, image reflections, image background variation, image shape, and other characteristics of the image that can be indicative of an object in the image being a potential spoofing device. Based on the measured detection of at least one of the aforementioned image properties, the described systems and methods can be used to determine whether an object to be imaged is a real/actual live human user or an electronic device that is the basis for a spoofing attack.

In this context, FIG. 5 illustrates a block diagram of another example system 300 for spoofing attack detection during live image capture. The implementation of FIG. 5 can include one or more features having corresponding reference numbers that are also depicted in the implementations of FIG. 1 and FIG. 3. More particularly, in addition to the functionality described below, in some implementations, system 300 can be also configured to execute all functionality described above with reference to the implementations of FIGS. 1-4. Hence, descriptions for certain features discussed above for system 100 can be referenced for equivalent features also depicted in system 300.

System 300 generally includes imaging device 302 configured to capture an image of an example object such as object 308 (e.g., an electronic device) or human user 310. In some implementations, imaging device 302 may be a camera, a laptop computer, a desktop computer, a cellular smartphone device (e.g., an iPhone, Samsung Galaxy, or an Android device), or any other electronic device capable of capturing an image of an electronic device 308 or capturing an image of an example human user 310.

Imaging device 302 generally includes processing unit 104, storage medium 106, and image property measurement unit 305. In an alternative embodiment, system 300 may include other computing resources/devices (e.g., cloud-based servers) that provide additional processing options for performing one or more the determinations and calculations described below.

Image property measurement unit (IMU) 305 generally includes, imaging sensor 108, imaging lens 109, glare and reflection (GR) sensing logic 304, and edge detection and background (EDB) sensing logic 306. In general, IMU 305 cooperates with processing unit 104 and storage medium 106 to perform a multiple computing operations and tasks relative to spoofing attack detection. In some implementations, the computing operations occur when imaging device 302 is used to capture or acquire an image of an object, such as a potential spoofing device 308 or human user 310.

One or more features of IMU 305 can correspond to computing logic or software instructions configured to measure or detect one or more image properties of an object to be captured/imaged. In some implementations, programmed code or software instructions for sensing logic 304 and 306 can be executed by processing unit 104 to cause device 302 to perform one or more functions. For example, in response to execution of the programmed code for sensing logic 304, 306, processing unit 104 can cause one or more hardware sensing features of device 302 to detect image properties of an example image.

As indicated above, an object to be imaged may be a live human user 310 or a potential spoofing object 308. In the implementation of FIG. 5, imaging device 302 is configured to use detected glare, reflection, or edge and background properties of an example image to determine whether an object to be imaged is a spoofing device. In some implementations, imaging device 302 can include one or more sensors or sensing features that are configured to detect or determine properties of an image that correspond to properties of an object depicted in an image.

For example, sensing features of device 302 can be configured to detect a glare property 312 of object 308, a reflection property 314 of object 308, an edge property 316 of object 308, and/or a background property 318 of object 308. In some implementations, although depicted in FIG. 5 as an electronic device, object 308 can be a variety of objects that are capable displaying an image of a human individual. For example, object 308 can be an identification card or still-photo such as object 114C depicted in FIG. 3.

Properties of an item to be imaged can be detected based on analysis of a digital image or live digital rendering that includes a depiction or representation of the item. Detection of one or more image properties of an item to be imaged enables imaging device 302 to determine whether the item is an actual live human user 310 or an actual or potential spoofing attack object/device 308 (e.g., a device displaying a still-photo or video replay of a human user).

Imaging device 302 can also include a signal indicator function (indicator 119) that broadcasts, signals, or otherwise notifies an authorized system of the determination regarding whether an object to be imaged is a live human user or a spoofing attack object. In some implementations, analysis of a digital image or object rendering to determine properties of the object is performed using computing devices such as a cloud-based server device. Some cloud-based server devices may include processing and storage capabilities that are substantially similar to capabilities of processing unit 104 and storage medium 106.

Sensing logic 304 is executed by processing unit 104 to cause detection of glare and reflection image properties that can be associated with an example digital image. The example digital image can include an object 308 that is a computing device (e.g., a smartphone phone device, a laptop, or display of a computing device) or an identification card/document or other physical item that includes an image of an individual.

Glare property 312 can correspond to detected glare that is associated with a display of object 308. In some implementations, object 308 is an example computing device or a display/display screen of an electronic device. Alternatively, glare property 312 can correspond to detected glare that is associated with an image of an identification card or image document that can correspond to object 308. For example, a display screen or substrate material of object 308 can include detectable physical attributes, e.g., glass/plastic features or other glare inducing features, that can cause the appearance of light being scattered or flared in response to a light waves interacting with an exterior surface of object 308.

Imaging device 302 executes one or more software instructions to detect glare property 312 and reflection property 314. For example, device 302 can use sensing logic 304 to detect one or more over saturated pixels. In some implementations, over saturated pixels can correspond to, or be detected for, image data relating to a digital rendering of object 308, but is not detected for image data relating to a digital rendering of human user 310.

Detection of one or more oversaturated pixels can correspond to exterior surface portions of an item/object that indicate excessive or overly bright areas. In particular, detection of one or more oversaturated pixels can indicate a potential spoofing attack is being attempted during a live image capture session. For example, detection of oversaturated pixels can indicate areas of excessive brightness that represents light glare/reflection relative to an exterior glass lens that covers an electronic display.

These surface areas of excessive brightness can occur based on environmental reflections or other natural or artificial light waves that interact with the exterior surface of an item (e.g., exterior lens covering an electronic display of spoofing device). In some implementations, natural or artificial light waves interact with the exterior surface of the item by reflecting off the item. Such reflections can be received by device 302 via imaging lens 109 and pixel data relating to the reflections can be processed and analyzed to determine one or more properties of the item.

For example, device 302 can use processing unit 104 to execute sensing logic 304 for performing image and pixel data analysis functions. In response to analyzing pixel data for a digital image, device 302 can detect at least one glare property 312 of object 308 or detect at least one reflection property 314 of object 308. For example, device 302 can detect glare property 312 of object 308 by determining whether a subset of pixels indicate oversaturation, where the pixels are used to construct a digital image of object 308.

In some implementations, oversaturation is determined based on a parameter value(s) for a pixel (or set of pixels) exceeding a threshold parameter value. The parameter value for the pixel can correspond to measured brightness of a surface area or region of device 308. Hence, device 302 can use the parameter values to detect or determine which pixels are oversaturated and then determine a glare property 312 or a reflection property 314 based on the oversaturated pixels.

In some implementations, device 302 computes or determines a magnitude of pixel saturation based on a computed percentage of pixels that are determined to be oversaturated. Hence, device 302 can use an area-based pixel saturation measurement for spoofing attack detection, where a higher percentage of oversaturated pixels indicates a higher probability that an image being detected in an image frame is a spoofed image.

In some implementations, parameter values can range from 0.1 (low brightness) to 1.0 (high brightness) to represent a measured brightness of a particular surface area or region of device 308. For example, pixel data including parameter values that exceed a first threshold value (e.g., 0.65 brightness measure) can indicate that a glare property 312 of object 308 has been detected. Likewise, pixel data including parameter values that exceed a second threshold value (e.g., 0.85 brightness measure) can indicate that a reflection property 314 of object 308 has been detected.

In general, glare property 312 and reflection property 314 that can be detected on an exterior surface or lens of a display device are distinct from any minor glare and reflective properties that can be associated with a live human face. Hence, detected glare property 312 and reflection property 314 can be used to reliably detect whether, for example, an electronic device is being used to spoof an image of a live human user.

For example, glare and reflection characteristics associated with an object to be imaged (e.g., either on/around a person's face or on an electronic device) can exhibit certain patterns. In some implementations, patterns relating to glare and reflection characteristics for human user 310 can provide reliable indications for determining whether an item/object being imaged is likely a spoofed object or a live human.

Light glare characteristics can also exhibit certain hot spot patterns, where the hot spots may be caused by certain infrared (IR) light waves that are detectable by imaging lens 109 of device 302. In some implementations, glare or hot spot patterns may be consistent with glare or hot spot patterns that are known to be associated with certain exterior display surfaces of electronic devices, e.g., cellphones, laptops, or tablet computing devices. These known properties may be stored in memory of storage medium 106.

In some implementations, processing unit 304 accesses storage medium 106 to compare detected glare, reflection, or hot spot data for object 308 (or human user 310) to known glare, reflection, or hot spot data. Based on the comparison, device 302 can determine whether an item/object or person being imaged is live human user, or an image of a human user that is being displayed on a spoofing device (e.g., tablet or smartphone).

Sensing logic 306 is executed by processing unit 104 to cause detection of edge and background image properties that can be associated with an example digital image. As indicated above, the example digital image can include an object 308 that is a computing device, an identification card/document, or another physical item that includes an image of a human user.

Edge property 316 can correspond to a detected frame or outline that is associated with a display or housing of a computing device that corresponds to object 308. Alternatively, edge property 316 can correspond to a detected frame or outline that is associated with an identification card or image document that can correspond to object 308 or object 114C. For example, an ID card, a display screen, an electronic device housing, or a protective case of an object 308 can include a physical edge or outline that is defined by an exterior portion of the object 308.

Edge property 316 can be a detected frame or boundary that is associated with a display, housing, or exterior of object 308, when object 308 is an example computing device. Alternatively, edge property 316 can be a detected frame or boundary that is associated with an image of an identification card or image document that can correspond to object 308.

Imaging device 302 executes one or more software instructions to detect edge property 316 and background property 308. For example, device 302 can use sensing logic 306 to detect one or more edges or boundaries of objects within an image and to detect one or more background attributes relative to objects within an image. In some implementations, edges or boundaries can correspond to, or be detected for, image data relating to a digital rendering of object 308, but is not detected for image data relating to a digital rendering of human user 310.

Detection of a boundary can correspond to an object frame defined by an exterior surface portion of an item/object that indicates is a physical device or identification document, instead of live human user. In particular, detection of an object boundary or frame can indicate that a potential spoofing attack is being attempted during a live image capture session.

For example, device 302 can use processing unit 104 to execute sensing logic 306 for performing image and pixel data analysis functions. In response to analyzing pixel data for a digital image, device 302 can detect at least one edge property 316 of object 308 or detect at least one background property 318 of object 308. For example, device 302 can detect edge property 316 of object 308 by determining whether a subset of pixels indicate certain discontinuities in brightness. In some implementations, device 302 detects edge property 316 and background property 318 of object 308 by determining whether a subset of pixels indicate certain discontinuities in brightness, where the discontinuities can be caused by contrasts associated with detected color properties of an image.

In some implementations, discontinuities in brightness and contrasts between detected color properties of an image are determined based on a parameter value(s) for certain image data exceeding a threshold parameter value. For example, brightness discontinuities can be determined based on analysis of pixel parameter values for image pixel data, while contrasts between color properties can be determined based on analysis of color parameter values generated by an example RGB color model of device 302.

For example, regarding brightness discontinuities of an image, image data including pixel parameter values for a given area of an image can be analyzed to determine brightness values. Device 302 can analyze the brightness values to determine whether disparities or delta between sets of values indicate a brightness discontinuity that corresponds to detected edge or boundary of an item or object 308. In some implementations, a brightness discontinuity corresponds to a detected edge or boundary when a delta between sets of parameter values for detected brightness exceed a threshold delta.

Likewise, regarding contrasts between color properties of an image, color parameter values for a given area of an image can be analyzed to determine color values. Device 302 can analyze the color values to determine whether disparities or contrasts between sets of values indicate a particular color contrasts. Certain color contrasts can correspond to a detected background of an image. In some implementations, a contrast between color properties of an image corresponds to a detected background when a delta between sets of color values for respective areas of an image exceed a threshold delta.

For example, color parameter values for a given area of an image can indicate that a color disparity/contrast exists between a first image area 320 and a second image area 322. Hence, device 302 can determine that a color disparity/contrast exists between first image area 320 and a second image area 322. Device 302 can then detect background property 318 based on the determined the color contrast. For example, device 302 can determine background property 318 based on a particular computed difference/delta between color values for first image area 320 (e.g., 0.31) and color values for second image area 322 (e.g., 0.83) exceeding a threshold delta (e.g., 0.4). In some implementations, color values can be described as parameter values that indicate image color properties generated by an example RGB model of device 302.

In general, for an image that includes a spoofing device or related spoofing object, edge property 316 and background property 318 will be distinct from any minor frames or boundaries as well as any color disparities or background properties that can be associated with an image of a live human face. Hence, detected edge property 316 and background property 318 can be used to reliably detect whether, for example, an electronic device is being used to spoof an image of a live human user.

FIG. 6 illustrates another flowchart of an example process 220 for spoofing attack detection during live image capture. At block 222 of process 220, for each image frame, imaging device 302 detects a presence of an object to be imaged which includes detecting whether the face of a live human user 310 is within the image frame. At block 224, process 220 includes imaging device 302 determining a first characteristic of the object to be imaged. In some implementations, the first characteristic of the object corresponds to either a glare property of the object, a reflection property of the object, or both. The object to be imaged can include a computing device (e.g., object 308), an electronic display of a computing device, an identification document 114C, or a live human user 310.

At block 226, process 220 includes imaging device 302 determining a second characteristic of the object to be imaged. In some implementations, the second characteristic of the object corresponds to either an edge property 316 of the object, a reflection property 318 of the object, or both. One or more characteristics of the object can be determined based on device 302 analyzing image data for a digital image that includes a digital representation of the object. In some implementations, device 302 provides image data to an example cloud-based computing system and the cloud-based system analyzes the image data to determine one or more characteristics or properties of the object depicted in the image frame.

At block 228, imaging device 302 determines whether one or more parameter values indicating the first characteristic of the object exceeds a first threshold parameter value or whether one or more parameter values indicating the second characteristic of the object exceeds a second threshold parameter value. At block 230, in response to determining whether one or more parameter values exceed a particular threshold parameter value, device 302 indicates whether the object to be imaged is a spoofed object, spoofing device, or an actual live human user.

In some implementations, the object to be imaged can be a live human user 310 that is positioned locally adjacent to device 302. In alternative embodiments in which a potential spoofing attack is attempted, the object to be measured is a spoofing object such as object 114B, object 114C, object 308. In some implementations, device 302 indicates whether the object to be imaged is a spoofing device or a live human user based on analysis performed using a cloud-based computing device.

In general, for items such as identification documents, photos on a sheet, or electronic device, an attempted spoofing action can include holding the item up to device 302 to spoof a selfie capture. In some instances, imaging device 302 can capture a digital image/picture of the item. The captured image can include a detected edge, frame, boundary, or background property (each described above) that appears around or behind the item during image capture. In other instances, imaging device 302 is configured to detect a glare, reflection, color, or brightness properties associated with the item (e.g., a first/second characteristic or property) based on parameter values.

Device 302 can then compare parameter values that indicate the first/second characteristic (or property) associated with the item to either a threshold parameter value or a related parameter value. Results of the comparison are used to determine whether a spoofing attack during live image capture is being attempted. In some implementations, parameter values and threshold comparisons for multiple image properties can be used simultaneously to determine whether a spoofing attack during live image capture is being attempted.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system.

A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer.

Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components.

The components of the system can be interconnected by any form or medium of digital data communication, e.g., a communication network. Examples of communication networks include a local area network (“LAN”) and a wide area network (“WAN”), e.g., the Internet. The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, the method comprising:
detecting, by an imaging device, the presence of an object to be imaged;
measuring, by the imaging device, a distance between the imaging device and the object to be imaged;
using, by a computing device, the measured distance and at least one feature of the imaging device to determine a characteristic of the object to be imaged;
determining, by the computing device, whether the characteristic of the object exceeds a threshold; and
indicating, by the computing device, whether the object to be imaged is one of a spoofed object and an actual object.

2. The method of claim 1, wherein the determined characteristic of the object to be imaged is the size of the object.

3. The method of claim 1, wherein the at least one feature of the imaging device includes one of:
focal length of a lens of the imaging device,
size of an imaging sensor of the imaging device,
image pixel resolution of the imaging sensor, and
object size of the image in pixels.

4. The method of claim 3, wherein determining the characteristic of the object to be imaged includes using a width of an image detected by the imaging device and a width of the imaging sensor.

5. The method of claim 4, wherein the object to be imaged is a human face and the distance between the imaging device and the object is measured based on a distance between a first pupil of the human face and a second pupil of the human face.

6. The method of claim 5, wherein the distance between a first pupil of the human face and a second pupil of the human face is a distance in pixels associated with an image detected by the imaging device.

7. A computer-implemented method comprising:
detecting, by an imaging device, the presence of an object to be imaged;
determining, by the imaging device, a first characteristic of the object to be imaged;
determining, by the imaging device, a second characteristic of the object to be imaged;
determining, by a computing device, whether a parameter value exceeds a threshold parameter value, where the parameter value indicates the first characteristic or the second characteristic; and
in response to determining whether the parameter value exceeds the threshold parameter value, indicating, by the computing device, that the object to be imaged is one of a spoofed object or an actual object.

8. The method of claim 7, wherein the parameter value indicates at least one of:
a characteristic of at least a subset of pixel data associated with image data for the object to be imaged; or
a color property of at least one image area of the image data for the object to be imaged.

9. The method of claim 8, wherein determining whether the parameter value exceeds the threshold parameter value comprises:
analyzing the pixel data to determine whether one or more pixels are oversaturated;
in response to determining whether one or more pixels are oversaturated, computing a percentage of pixels that are determined to be oversaturated; and
determining a magnitude of pixel saturation based on the percentage of pixels that are determined to be oversaturated.

10. The method of claim 8, wherein a higher percentage of oversaturated pixels indicates a higher probability that an object to be imaged is an electronic device for displaying a spoofing image.

11. The method of claim 7, wherein the first characteristic of the object to be imaged is a glare property of the object, a reflection property of the object, or the glare property and the reflection property.

12. The method of claim 8, wherein the object is an electronic device having a display screen, the electronic device including detectable attributes that are associated with a glare property of the object, a reflection property of the object, or a frame of the object.

13. The method of claim 7, wherein the second characteristic of the object to be imaged is an edge property of the object, a background property of an image depicting the object, or the edge property of the object and the background property of the image depicting the object.

14. An electronic system, comprising:
one or more processing devices; and
one or more non-transitory machine-readable storage devices for storing instructions that are executable by the one or more processing devices to cause performance of operations comprising:
detecting, by an imaging device, the presence of an object to be imaged;
determining, by the imaging device, a first characteristic of the object to be imaged;
determining, by the imaging device, a second characteristic of the object to be imaged;
determining, by a computing device, whether a parameter value exceeds a threshold parameter value, where the parameter value indicates the first characteristic or the second characteristic; and
in response to determining whether the parameter value exceeds the threshold parameter value, indicating, by the computing device, that the object to be imaged is one of a spoofed object or an actual object.

15. The electronic system of claim 14, wherein the imaging device includes one or more features, and wherein determining a first characteristic of the object to be imaged, comprises:
computing a distance between the imaging device and the object to be imaged; and
determining, by the computing device, the first characteristic of the object to be imaged based on the computed distance and using at least one feature of the imaging device.

16. The electronic system of claim 15, wherein determining the first characteristic of the object to be imaged comprises:
determining a width of an image generated by the imaging device; and
determining the first characteristic of the object to be imaged based on the width of the image and the width of the image sensor.

17. The electronic system of claim 16, wherein the object to be imaged is a human face and the distance between the imaging device and the object is measured based on a distance between a first pupil of the human face and a second pupil of the human face.

18. The electronic system of claim 14, wherein determining the second characteristic of the object to be imaged comprises:
analyzing image pixel data associated with a digital representation of the image;
in response to analyzing, determining one or more parameter values for a subset of image pixels; and
determining the second characteristic of the object to be imaged based on parameter values.

19. The electronic system of claim 14, wherein the first characteristic of the object to be imaged is the size of the object.

20. The electronic system of claim 14, wherein the second characteristic of the object to be imaged is a glare property of the object, a reflection property of the object, or the glare property and the reflection property.
